(19) United States
(12) Patent Application Publication
(10) Pub. No.: US 2015/0333618 A1
(43) Pub. Date: Nov. 19, 2015

(54) LOW VOLTAGE RIDE-THROUGH APPARATUS CAPABLE OF FLUX COMPENSATION AND PEAK CURRENT MANAGEMENT

(71) Applicant: National Tsing Hua University, Hsinchu City (TW)

(72) Inventors: Po-Tai Cheng, Hsinchu City (TW); Hsin-Chih Chen, Kaohsiung City (TW)

(21) Appl. No.: 14/504,534

(22) Filed: Oct. 2, 2014

(30) Foreign Application Priority Data
May 16, 2014 (TW) 103117417

(51) Int. Cl. H02M 1/32; H02M 7/533

(52) U.S. Cl. CPC H02M 1/32; H02M 7/533

(57) ABSTRACT

A low voltage ride-through (LVRT) apparatus capable of flux compensation and peak current management is disclosed, which comprises a converter; a space vector modulator, connected to the converter; a current controller, connected to the space vector modulator; an grid realization system, connected to the current controller; a flux offset compensator, connected to the current controller; a filter, connected to the converter; and a transformer, connected to the filter. In this manner, the LVRT apparatus may be connected to an associated grid side (commercial power), and thus applied onto a direct current (DC) to alternating current (AC) system for renewable energy source. When the grid side is failed, a flux offset on a transformer may be eliminated, to avoid an inrush current from rising after a recovery of failure exclude voltage, so that the requirement of the grid operation may be satisfied.

### FIELD OF THE INVENTION

The present invention relates to a low-voltage ride-through (LVRT) apparatus capable of flux compensation and peak current management, and particularly to such apparatus which is applied onto a direct current (DC) to alternating current (AC) system for renewable energy source by connecting to an associated grid side (commercial power), and may eliminate a flux offset in a transformer when the grid voltage is reduced, to avoid an inrush current from rising after a recovery of failure exclude voltage, so that it may meet the requirement of the grid operation.

### DESCRIPTION OF THE RELATED ART

For the last decade, since the decrease of the petrochemical material and the abrupt rise of anti-nuclear activities and environmental consciousness, energy saving and carbon reduction have become an issue followed with interest.

Therefore, there has been an explosive growth regarding alternative energy sources and the associated theses. With more and more distributed electric sources connected to an alternating current (AC) grid through a commercial power in-parallel converter, the electric power company sets up a regulation for low voltage ride-through (LVRT) for operational stability of the grid when the voltage has an abrupt reduction, which requires the distributed electric power has to be kept in a connection state with the grid in some particular condition, and the distributed electric power has to provide a reactive power current to support the grid voltage.

These commercial paralleled converters are typically connected to the grid through a transformer, and the transformer has to face an imbalance voltage when the abruptly reduced voltage occurs, where the imbalance voltage may generate an offset on a flux of the transformer. When the voltage recovers, this abrupt voltage variation may push the flux of the transformer to be saturated and further generate an inrush current, and which shortens lifetime of the transformer and thus may not meet the corresponding requirement at the time of the grid operation.

### SUMMARY OF THE INVENTION

It is, therefore, an object of the present invention to provide a low voltage ride-through (LVRT) apparatus capable of flux compensation and peak current management, which may be connected to an associated grid side (commercial power) in use and applied onto a direct current (DC) to alternating current (AC) system for renewable energy source. When the grid side is failed, a flux offset compensator may be used to eliminate a flux offset on a transformer to avoid an inrush current from rising after a recovery of failure exclude voltage, so that the requirement of the grid operation may be satisfied.

To achieve the above object, the low voltage ride-through (LVRT) apparatus capable of flux compensation and peak current management according to the present invention comprises a converter; a space vector modulator, connected to the converter; a current controller, connected to the space vector modulator; an grid realization system, connected to the current controller; a flux offset compensator, connected to the current controller; a filter, connected to the converter; and a transformer, connected to the filter.

In an embodiment, the converter comprises a renewable energy source, a plurality of power transistors, a plurality of diodes, and a plurality of capacitors connected to one another, the renewable energy source being specially connected to the vector modulator.

In an embodiment, among the current controller, the grid realization system and the flux offset compensator are connected to a plurality of coordination transfer units and a plurality of adders.

In an embodiment, the flux offset compensator comprises at least two low pass filters (LPFs) and a proportion controller connected to each of the LPFs.

In an embodiment, the filter comprises a plurality of inducers and capacitors.

In an embodiment, the transformer is a Δ-Y transformer.

In an embodiment, the transformer is further connected to a commercial power.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture according to the present invention;

FIG. 2 is a schematic diagram of an equivalent circuit according to the present invention;

FIG. 3 is a schematic diagram of a transformer according to the present invention;

FIG. 4 is schematic diagram of a flux offset current generated by a transformer according to the present invention;

FIG. 5 is a schematic diagram of a flux offset compensator according to the present invention;

FIG. 6 is a schematic diagram of a current waveform obtained on the flux offset compensator according to the present invention; and

FIG. 7 is a schematic diagram of a current waveform obtained on the flux offset compensator according to the present invention.

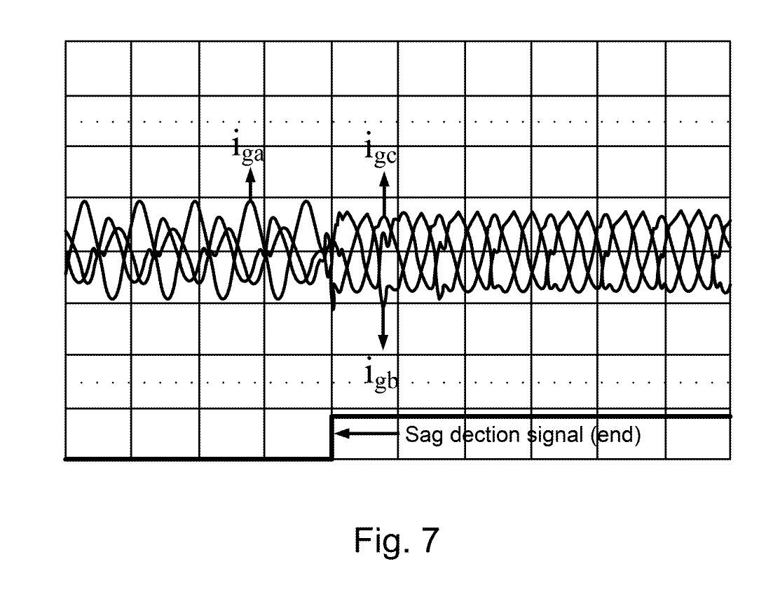

### DESCRIPTION OF THE PREFERRED EMBODIMENTS

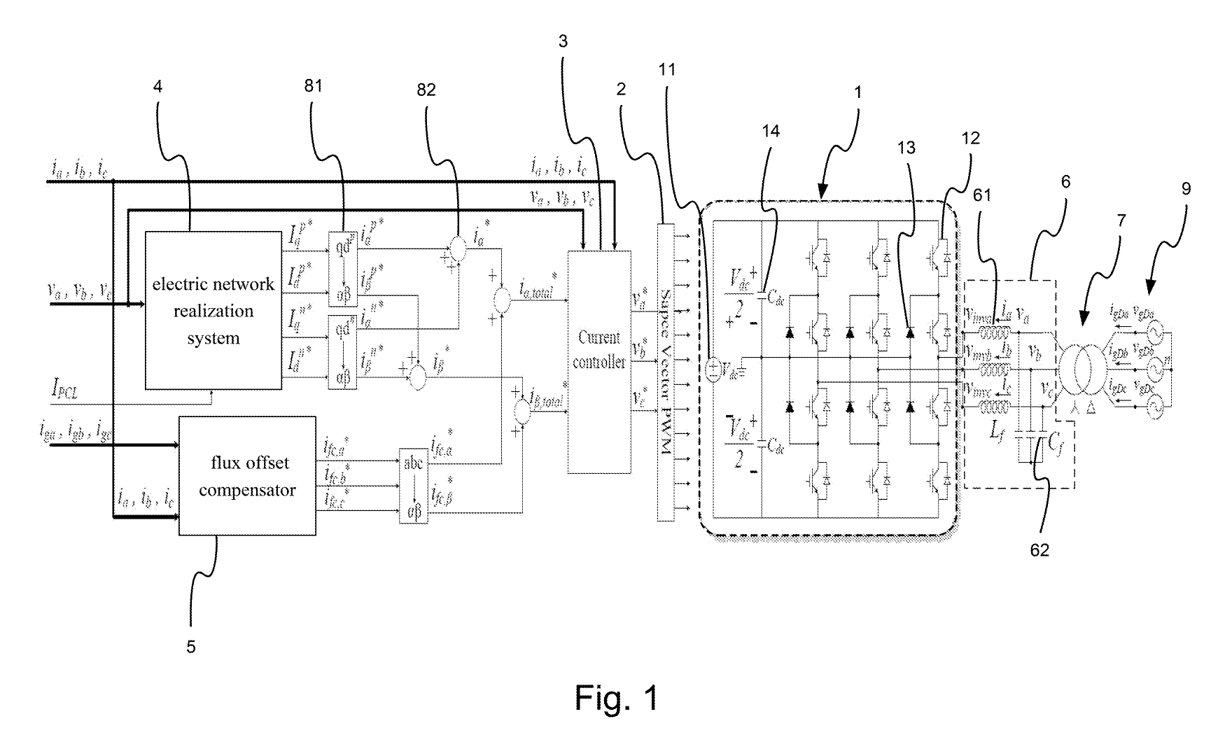

Now referring to FIG. 1 through FIG. 4, which are a schematic diagram of a basic architecture according to the present invention, a schematic diagram of an equivalent circuit according to the present invention, a schematic diagram of a transformer according to the present invention, and a flux offset current generated by a transformer according to the present invention, respectively.

As shown, the LVRT apparatus capable of flux compensation and peak current management comprises a transformer 1, a space vector modulator 2, a current controller 3, an grid realization system 4, a flux offset compensator 5, a filter 6, and a transformer 7.

The transformer 1 comprises a renewable energy source 11, a plurality of power transistors 12, a plurality of diodes 13, and a plurality of capacitors 14, which are connected to one another.

The renewable energy source 11 of the transformer 1 is connected to the space vector modulator 2.

The current controller 3 is connected to the space vector modulator 2.

The grid realization system 4 is connected to the current controller 3.

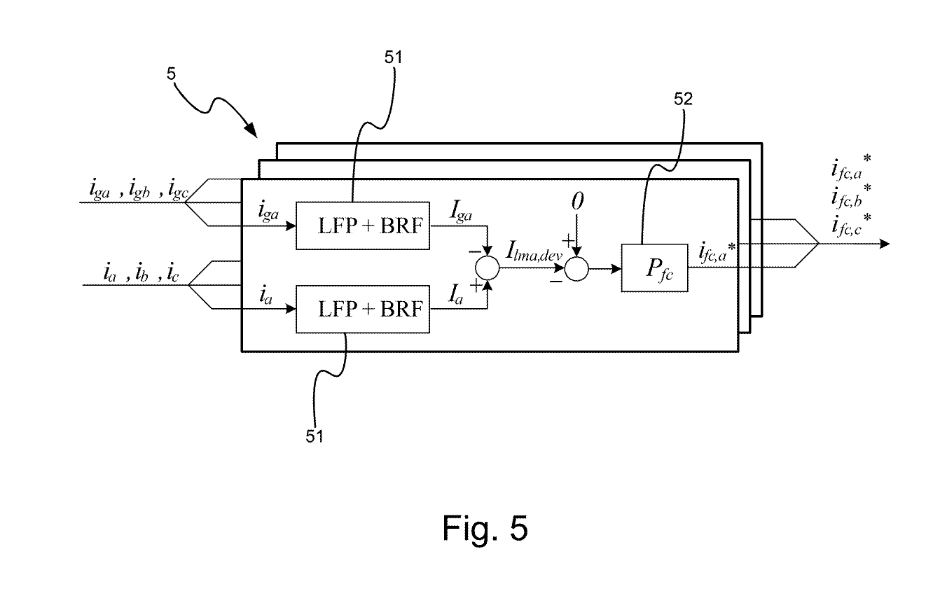

The flux offset compensator 5 is connected to the current controller 3. Among the current controller 3, the grid realization system 4 and the flux offset compensator 5 are connected to a plurality of coordination transfer units 81 and a plurality of adders 82. Further, the flux offset compensator 5 comprises at least two low pass filters (LPFs) 51 and a proportion controller 52 connected to each of the LPFs 51, which are shown in FIG. 5.

The filter 6 is connected to the transformer 1, and the filter 6 comprises a plurality of inductors 61 and capacitors 62.

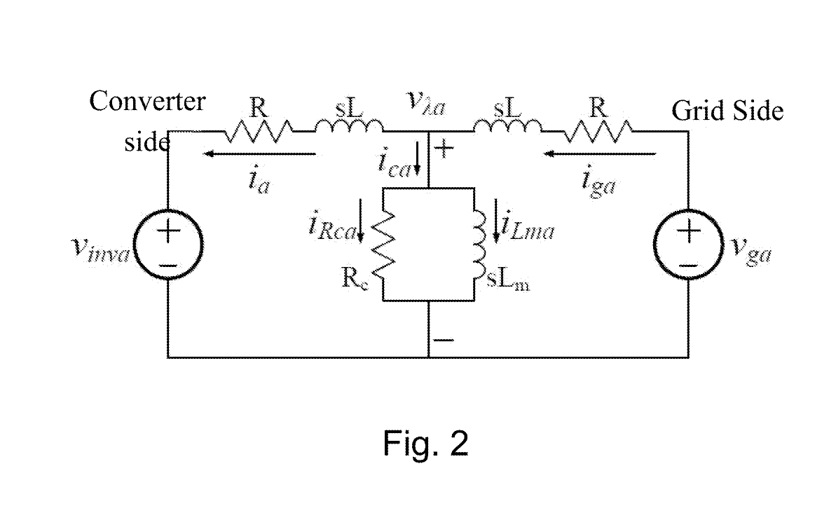

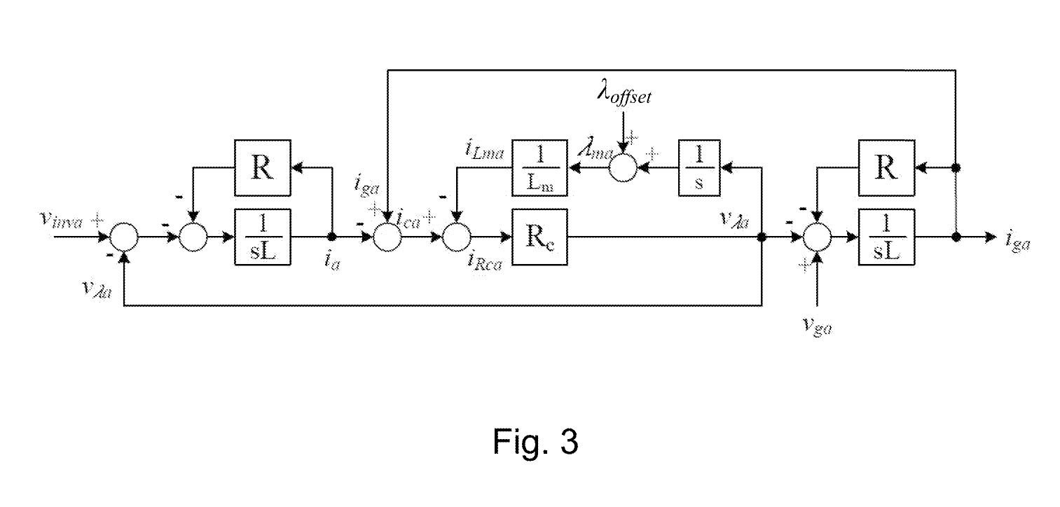

The transformer 7 is a Δ-Y transformer and connected to the filter 6, and has its equivalent circuit diagram and block diagram shown in FIG. 2 and FIG. 3, respectively. Further, the transformer 7 is connected to an grid side (commercial power) 9.

When the present invention is operated, it may be connected to the grid side (commercial power) 9, and work by combining functions of the transformer 1, the space vector modulator 2, the current controller 3, the grid realization system 4, the flux offset compensator 5, the filter 6 and the transformer 7. As such, a DC to AC system for a renewable energy source 11.

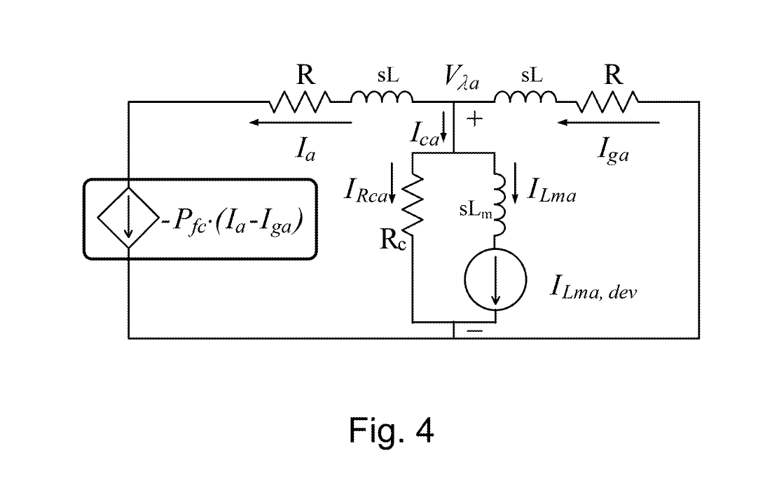

When the grid side 9 has a failure, a flux offset current is generated on the transformer 7, as shown as ia and iga in FIG. 4, and then feedback to the flux offset compensator 5.

Since the flux offset current frequency is a component corresponding to an offset of a DC component, and the renewable energy source 11 is arranged at the grid side 9 featuring an AC power, the flux offset currents (ia and iga) has the AC component existing at the grid side 9 when being feedback. Hence, the LPF of the flux offset current is used to filter out the AC component from the feedback flux offset currents (ia and iga) and the DC component is reserved.

After the detected flux offset current flows through the LPF and the bandpass filter (BPF) 51, the flux offset currents ia and iga lauch an operation of first addition and then deduction, to obtain an exact flux offset power. At this time, the flux offset compensator 5 issues a command to eliminate the flux offset current down to zero, which subsequently controls a current source to eliminate the flux offset current amount to zero. Then, the proportion controller 52 is used to generate a current desired to be outputted. As such, the requirement of the grid realization system 4 may be satisfied.

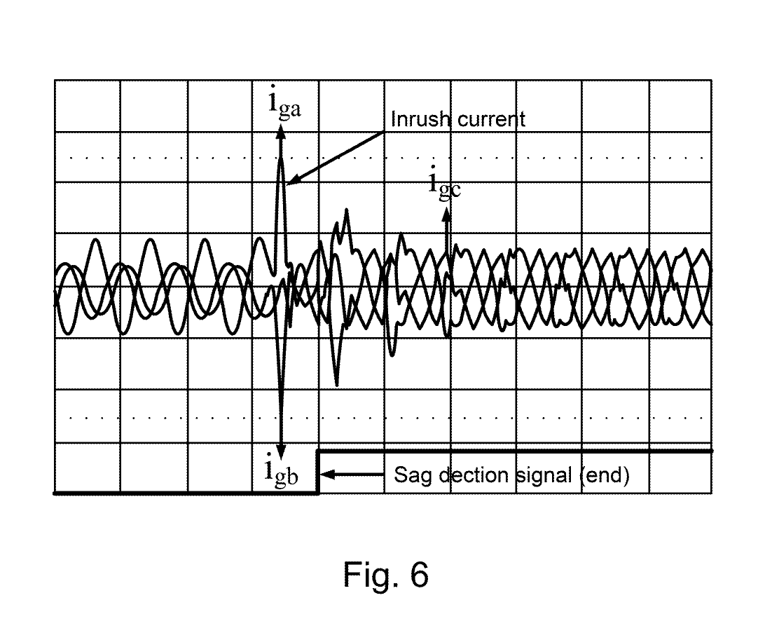

Seen from FIG. 6, the current without experiencing the elimination of the flux offset compensator has an inrush current. On the contrary, the inrush current does not exist after the flux offset current is eliminated by the flux offset compensator 5 of the present invention. As such, after the grid side 9 recovers from a failure, the flux offset compensator 5 eliminates the flux offset on the transformer so that a feedback current is avoided from being generated. In this manner, the requirement of grid operation may be satisfied.

In view of the above, the LVRT apparatus capable of flux compensation and peak current management may be connected to an associated may effectively improve the demerits of the prior art apparatus. The inventive apparatus may be connected to the grid side (commercial power), and thus applied onto a DC to AC system for renewable energy source. When the grid side is failed, a flux offset on a transformer may be eliminated, to avoid the inrush current from rising after a recovery of failure exclude voltage, so that it may meet the requirement of the grid operation. From all these views, the present invention may be deemed as being more effective, practical, useful for the consumer's demand, and thus may meet with the requirements for a patent.

The above description is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. A low voltage ride-through (LVRT) apparatus capable of flux compensation and peak current management, comprising:
a converter;
a space vector modulator, connected to the converter;
a current controller, connected to the space vector modulator;
an grid realization system, connected to the current controller;
a flux offset compensator, connected to the current controller;
a filter, connected to the converter; and
a transformer, connected to the filter.

2. The low voltage ride-through (LVRT) apparatus capable of flux compensation and peak current management as claimed in claim 1, wherein the converter comprises a renewable energy source, a plurality of power transistors, a plurality of diodes, and a plurality of capacitors connected to one another, the renewable energy source being spaciously connected to the vector modulator.

3. The low voltage ride-through (LVRT) apparatus capable of flux compensation and peak current management as claimed in claim 1, wherein among the current controller, the grid realization system and the flux offset compensator are connected to a plurality of coordination transfer units and a plurality of adders.

4. The low voltage ride-through (LVRT) apparatus capable of flux compensation and peak current management as claimed in claim 1, wherein the flux offset compensator comprises at least two low pass filters (LPFs) and a proportion controller connected to each of the LPFs.

5. The low voltage ride-through (LVRT) apparatus capable of flux compensation and peak current management as claimed in claim 1, wherein the filter comprises a plurality of inducers and capacitors.

6. The low voltage ride-through (LVRT) apparatus capable of flux compensation and peak current management as claimed in claim 1, wherein the transformer is a Δ-Y transformer.

7. The low voltage ride-through (LVRT) apparatus capable of flux compensation and peak current management as claimed in claim 1, wherein the transformer is further connected to an grid realization side.
